(19) United States
(12) Patent Application Publication
(10) Pub. No.: US 2014/0307767 A1
(43) Pub. Date: Oct. 16, 2014

(54) Methods and Systems for Modulation Classification

(71) Applicant: UURMI SYSTEMS PRIVATE LIMITED, Hyderabad (IN)

(72) Inventors: Krishna Karthik N. Anantha, Hyderabad (IN); M. S. Jameerali, Hyderabad (IN)

(73) Assignee: Uurmi Systems Private Limited, Hyderabad (IN)

(21) Appl. No.: 13/863,486

(22) Filed: Apr. 16, 2013

(51) Int. Cl. H04L 27/00; H04B 1/10; H04L 27/01

(52) U.S. Cl. CPC H04L 27/0012; H04L 27/01; H04B 1/1081
USPC 375/232

(57) ABSTRACT

A method and wireless receiver for determining a modulation format of a transmitted signal from a received signal over a multipath channel are disclosed. The received signal has a frequency offset with respect to the transmitted signal. The wireless receiver down-samples the received signal. The down-sampled signal is equalized in order to mitigate an effect of multipath channel. Then the wireless receiver applies differential processing on the equalized signal to convert the frequency offset into a constant phase offset. Thereafter, values of one or more moment based features for the equalized signal are determined by the wireless receiver. The modulation format of the received signal is then determined based on the values of one or more moment based features.

### TECHNICAL FIELD

The presently disclosed embodiments generally relate to wireless communication. More particularly, the presently disclosed embodiments relate to a technique of determining a modulation format from a received signal.

### BACKGROUND

Blind Modulation Classification (BMC) is a process of determining a modulation format of a transmitted signal from a received signal. It is an intermediate operation between signal detection and demodulation, and is useful in various applications such as cognitive radio, surveillance, intelligent receivers and electronic warfare. In the presence of various practical problems, such as, carrier frequency offset, carrier phase offset, timing offset and multipath fading channel, the BMC is a challenging task.

The approaches followed in BMC can be broadly divided into two types: decision-theoretic approach and feature-based approach. The decision-theoretic classifiers are optimal, but they generally suffer from high computational complexity and are very sensitive to model mismatches. The feature-based methods rely on the statistical features extracted from the received data for modulation classification. The asymptotic values of the features are calculated off-line and the decision is made on the best match of the features estimated from the received signal. The feature-based approaches are often simple to implement and can give results close to the optimal. The most commonly used features are based on the instantaneous features of the received signal, or on various higher-order statistics such as moments or cumulants.

Various known techniques of the BMC assume either an Additive White Gaussian Noise (AWGN) or Line-of-Sight (LOS) channel. The performance of these techniques might degrade in the presence of multipath channels.

Further, various Second-Order Statistics (SOS) based BMC techniques are also known. Although the SOS based BMC techniques require significantly less number of samples for channel estimation, they require exact knowledge of channel length. Further, the performance of these techniques degrade significantly even at moderate SNRs around 15 dB. Also, it is known that the SOS based BMC techniques cannot be used when sub-channels have a common root which could occur due to imperfect knowledge of channel length. Furthermore, the SOS for channel identification is affected by frequency offsets.

Various other techniques for BMC in the presence of multipath channels is also known, however implementation of these techniques require perfect frequency synchronization and rectangular pulse shape at the transmitter. The performance of these algorithms might degrade in the presence of frequency offsets and other pulse shapes.

Thus, determining/classifying the modulation format in presence of both the multipath channels and frequency offsets is still a challenge.

### SUMMARY

According to various embodiments illustrated herein, there is provided a method implementable in a wireless receiver method for determining a modulation format of a transmitted signal from a received signal over a multipath channel, wherein the received signal has a frequency offset with respect to the transmitted signal. The method comprises down-sampling the received signal to obtain a second down-sampled signal at a second predefined rate. The second down-sampled signal is equalized in order to mitigate effect of the multipath channel. Thereafter, differential processing is applied on the equalized second down-sampled signal to convert the frequency offset into a constant phase offset. Values of one or more moment based features are determined for the equalized second down-sampled signal; and the modulation format of the received signal is then determined based on the values of one or more moment based features.

According to various embodiments illustrated herein, there is provided a wireless receiver for determining a modulation format of a transmitted signal from a received signal over a multipath channel, wherein the received signal has a frequency offset with respect to the transmitted signal. The wireless receiver comprises a signal processor and a memory. The memory comprises an equalizer module, a differential processing module, and a decision module. The equalizer module is configured for equalizing a second down-sampled signal in order to mitigate an effect of the multipath channel, wherein the second down-sampled signal is obtained from the received signal. The differential processing module is configured to convert the frequency offset into a constant phase offset in the equalized second down-sampled signal. The decision module is configured for determining the modulation format of the received signal based on values of one or more moment based features. The signal processor executes the equalizer module, the differential processing module, and the decision module.

According to various embodiments illustrated herein, there is provided a computer program product for use with a computer, the computer program product comprising a computer readable medium embodied therein a computer program code for determining a modulation format of a transmitted signal from a received signal over a multipath channel, wherein the received signal has a frequency offset with respect to the transmitted signal. The computer program code comprises program instructions for: down-sampling the received signal; equalizing the down-sampled signal in order to mitigate an effect of the multipath channel; applying differential processing on the equalized signal to convert the frequency offset into a constant phase offset; determining values of one or more moment based features for the equalized signal; and determining the modulation format of the received signal based on the values of one or more moment based features.

### BRIEF DESCRIPTION OF DRAWINGS

One or more embodiments are set forth in the drawings and in the following description. The appended claims particularly and distinctly point out and set forth the invention.

The accompanying drawings, which are incorporated in and constitute a part of the patent application, illustrate various embodiments of various aspects of the ongoing description. It will be appreciated that the illustrated element boundaries (e.g., boxes, groups of boxes, or other shapes) in the figures represent one example of the boundaries. One of ordinary skill in the art will appreciate that in some examples one element may be designed as multiple elements or that multiple elements may be designed as one element. In some examples, an element shown as an internal component of another element may be implemented as an external component and vice versa. Furthermore, elements may not be drawn to scale.

FIG. 1 is a block diagram illustrating a wireless receiver in accordance with at least one embodiment; and

FIG. 2 is a flow diagram illustrating a method for determining a modulation format in accordance with at least one embodiment.

### DETAILED DESCRIPTION

Before the present invention is described in further detail, it is to be understood that the invention is not limited to the particular embodiments described, as such may, of course, vary. It is also to be understood that the terminology used herein is for the purpose of describing particular embodiments only, and is not intended to be limiting, since the scope of the present invention will be limited only by the appended claims.

References to “one embodiment”, “an embodiment”, “at least one embodiment”, “one example”, “an example”, “for example” and so on, indicate that the embodiment(s) or example(s) so described may include a particular feature, structure, characteristic, property, element, or limitation, but that not every embodiment or example necessarily includes that particular feature, structure, characteristic, property, element or limitation. Furthermore, repeated use of the phrase “in one embodiment” does not necessarily refer to the same embodiment, though it may.

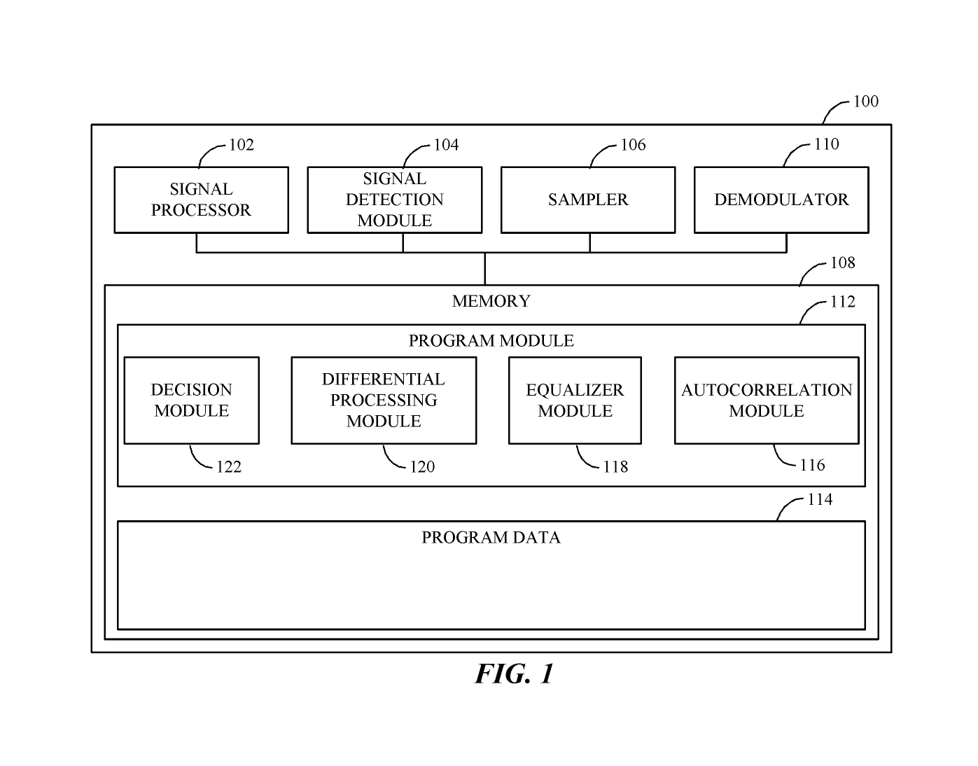

FIG. 1 is a block diagram illustrating a wireless receiver 100 in accordance with at least one embodiment. The wireless receiver 100 is capable of determining a modulation format of a transmitted signal from a received signal over a multipath channel, wherein the received signal has a frequency offset with respect to the transmitted signal. In an embodiment, the wireless receiver 100 includes a signal processor 102, a signal detection module 104, a sampler 106, a memory 108, and a demodulator 110. In another embodiment, the functionalities imparted by the signal processor 102 and various program instruction modules in the memory 108 (described below) may be implemented as an application-specific integrated circuit (ASIC) or a Field Programmable Gate Array (FPGA) programmed using hardware description language (HDL) such as Verilog.

The signal processor 102 may be realized as, for example, microprocessor (RISC or CISC), a digital signal processor (DSP). In an embodiment, the signal processor 102 is a multi-core processor. Various types of the memory 108 may include, but are not limited to, cache, RAM, ROM, PROM, EPROM, EEPROM, flash, SRAM, and DRAM. The memory 108 may be implemented in the form of a storage device, which can be a hard disk drive or a removable storage drive, such as, a floppy disk drive, USB memory, memory cards, and an optical disk drive.

The memory 108 includes a program module 112 and a program data 114. The program module 112 stores various program instruction modules, such as, an autocorrelation module 116, an equalizer module 118, a differential processing module 120, and a decision module 122. Each of these program instruction modules represents a group of program instructions being executed by the signal processor 102. The program data 114 represents a set of memory locations for holding the data accessible by the program module 112, the signal processor 102, and the demodulator 110.

The signal detection module 104 receives a transmitted signal received by one or more antenna (not shown) at the wireless receiver 100. In an embodiment, the signal detection module 104 may also increase signal strength of the signal if the received signal is weak. In an embodiment, the received signal is in the form of discrete samples. The signal detection module 104 may be implemented using various techniques such as, but not limited to, energy detection, cyclo-stationarity based signal sensing, Eigen value based signal sensing, FFT based signal sensing. Although, the signal detection module 104 is illustrated as hardware module, it can also be implemented, using the above mentioned techniques, as a program instructions module in the memory 108 without limiting the scope of the ongoing description.

The sampler 106 receives an output signal from the signal detection module 104. Thereafter, sampler 106 down-samples the received signal to obtain a first down-sampled signal at a first predefined rate and a second down-sampled signal at a second predefined rate. In an embodiment, the sampler 106 may be realized as a sample and hold circuit capable of sampling the received signal.

The autocorrelation module 116 is configured to determine a second order cyclic autocorrelation function based on the first down-sampled signal. The autocorrelation module 116 then stores the second order cyclic autocorrelation function in the program data 114.

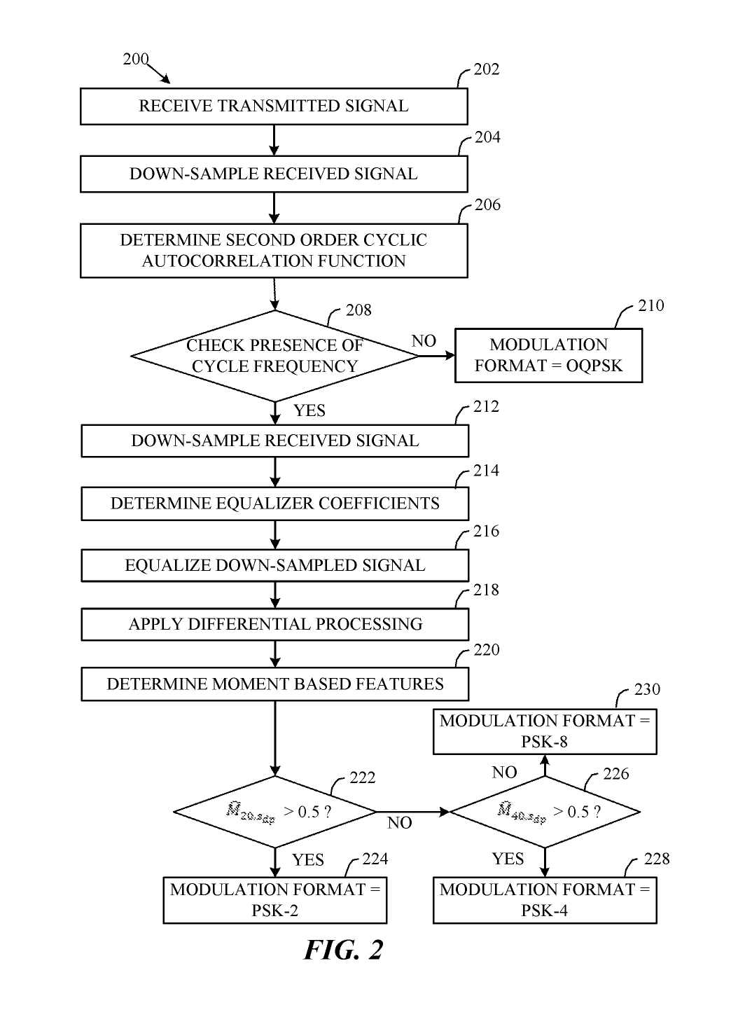

The equalizer module 118 is configured to determine one or more equalizer coefficients based on the second down-sampled signal by applying a Blind CMA technique. The equalizer module 118 stores the one or more equalizer coefficients in the program data 114. Thereafter, the equalizer module 118 is configured for equalizing the second down-sampled signal in order to mitigate the effect of multipath channel, wherein the second down-sampled signal is obtained from the received signal. This is further explained in conjunction with FIG. 2.

The differential processing module 120 is configured for converting frequency the offset into a constant phase offset in the equalized second down-sampled signal. This is further explained in conjunction with FIG. 2.

The decision module 122 is configured for determining the modulation format as an Offset Quadrature Phase Shift Keying (OQPSK) depending on a presence of a second order cycle frequency in the first down-sampled signal. The presence of the second order cycle frequency is determined based on the second order cyclic autocorrelation function. This is further explained in conjunction with FIG. 2.

If the second order cycle frequency is present, the decision module 122 is configured to determine values of one or more moment based features for the equalized second down-sampled signal. The decision module 122 stores the values of the one or more moment based features in the program data. Thereafter, depending on the values of one or more moment based features, the modulation format of the received signal is determined. In an embodiment, depending on the values of one or more moment based features, the modulation format can be determined as any of Phase Shift Keying (PSK)-2, PSK-4, or PSK-8. This is further explained in conjunction with FIG. 2.

The demodulation module 110 demodulates the received signal based on the determined modulation format. In an embodiment, the demodulation module 110 contains one or more demodulation circuits for performing demodulation of the received signal. For example, the demodulation module 110 contains different demodulation circuits for demodulating received signal having OQPSK, PSK-2, PSK-4, and PSK-8 modulation formats. Depending on the determined modulation format, the demodulation module 110 selects appropriate demodulation circuit to demodulate the received signal. It is to be noted that any suitable demodulation techniques may be used by the demodulation module 110 without limiting the scope of the ongoing description.

FIG. 2 is a flow diagram 200 illustrating a method for determining the modulation format in accordance with at least one embodiment. The method for determining the modulation format is performed at the wireless receiver 100.

At step 202, the transmitted signal is received by the signal detection module 104. In an embodiment, the transmitted complex baseband signal for PSK-{2, 4, 8} can be represented as:

x(t)=Σ_{k=-∞}^{∞}sₖg(t−kT) (1)

Where, sₖ is an information symbol from an unknown PSK signal constellation, T denotes symbol period, and g (t) represents a pulse shaping function, which in practice has a raised cosine spectrum.

Similarly, the transmitted signal in case of OQPSK can be represented as:

x(t)=Σ_{k=-∞}^{∞}Re{sₖ}g(t−kT)+jIm{sₖ}g(t−kT−T/2) (2)

Where, j=\sqrt{−1} and sₖ is drawn from a QPSK constellation. Let c(t) a baseband equivalent impulse (of finite duration) response of a quasi-static multipath fading physical channel and we assume that it is of finite duration. Then, the received complex signal can be modeled as:

y(t)=e^{j2πΔft+jθ}^{ₙ}Σₗ₌₀^{L-1}cₗx(t−τₗ)+b(t) (3)

Where cₗ, τₗ represent the complex gain and the corresponding path delay of the l^{th} path, ‘L’ represents the total number of multipath channel taps, b(.) is the complex white Gaussian noise with zero mean and variance σ², Δf denotes the frequency offset between the wireless receiver 100 and a wireless transmitter (not shown), i.e., the frequency offset between the received signal and the transmitted signal, θₙ denotes a phase offset between the wireless receiver 100 and the wireless transmitter. It is assumed that the symbols are uncorrelated and drawn from a constellation of zero mean and a unit variance, i.e., E[sₖ]=0 and E[sₖsₗ*]=δₖₗ, where δₖₗ is the Kronecker delta function and E [.] denotes the expectation operator.

At step 204, the received signal is down-sampled to obtain the first down-sampled signal at the first sample rate. The down-sampling is performed by the sampler 106. In an embodiment, the first sample rate is 2 samples/symbol.

At step 206, a second order cyclic autocorrelation function (R_{y}^{α}(τ)) is determined by the autocorrelation module 116 based on the first down-sampled signal. In an embodiment, the second order cyclic autocorrelation function may be represented as:

$${R}_{y}^{α} ( τ ) = {lim}_{z \to ∞} \frac{1}{Z} {\int }_{- Z / 2}^{Z / 2} y ( t + τ ) {y}^{*} ( t ) {e}^{- j2πα t} d t \qquad ( 4 )$$

The estimate of R_{y}^{α}(τ) at the cycle frequency α for τ=0, in the discrete case \hat{R}_{y}^{α}(0) is given as:

\hat{R}_{y}^{α}(0)=Σᵢ₌₀^{N-1}|y(iTₛ)|²e^{-2παi} (5)

Where, N represents the number of samples considered in the estimation, and a is chosen as 0.5 (=Ts/T).

At step 208, a test is performed to check the presence of a cycle frequency at Ts/T using the statistical test proposed in a publication entitled, “Statistical tests for the presence of cyclostationarity”, by A. V. Dandawate and G. B. Giannakis, published in IEEE Trans. Signal Processing, vol. 42, pp. 2355-2369, September 1994, which is herein incorporated by reference in its entirety. However, any other suitable tests may also be performed to check the presence of a cycle frequency without deviating from the scope of the ongoing description. In an embodiment, the decision module 122 performs this test.

If no presence of the cycle frequency is detected at Ts/T, step 210 is executed.

At step 210, the decision module 122 determines OQPSK as the modulation format of the received signal.

If the cycle frequency is detected at Ts/T, step 212 is executed.

At step 212, the received signal is again down-sampled by the sampler 106 to obtain the second down-sampled signal at the second sample rate. In an embodiment, the second sample rate is 1 sample/symbol.

At step 214, the equalizer module 118 determines one or more equalizer coefficients by applying a Blind CMA technique. In an embodiment, the since the Blind CMA technique operates at one sample/symbol, the second sample rate chosen/maintained at one sample/symbol. One such Blind CMA technique is disclosed in a publication entitled, “Self-Recovering Equalization and Carrier Tracking in Two-Dimensional Data Communication Systems”, by D. Godard, in IEEE Trans. Communications, vol. 28, pp. 1867{1875, November 1980, which is herein incorporated by reference in its entirety. However, any other suitable technique may also be applied to determine the equalizer coefficients without deviating from the scope of the ongoing description.

At step 216, the second down-sampled signal is equalized based on the estimated equalizer coefficients. By doing so, the equalizer module 118, removes the effects of both the multipath channel and pulse shape, and a sequence d (iT) with a running frequency offset is obtained:

d(iT)=Ce^{j2πΔfiT+jθ}sᵢ+n(iT) (6)

Where, C denotes a scaling factor.

At step 218, a differential processing is applied by the differential processing module 120 to the equalized signal to convert the frequency offset into a constant phase offset. In an embodiment, the differential processing comprises multiplying a symbol with a complex conjugate of previous symbol.

The differentially processed signal S_{dp,i}, for a symbol sequence {Sᵢ} may be defined as:

S_{dp,i}=SᵢS*ᵢ₋₁ (7)

Thus, a differentially processed sequence of d(i) is defined as d_{dp}(i), is represented as:

d_{dp}(i)=d(i)d*(i−1) (8)

At step 220, one or more moment based features are determined by the differential processing module 120. The moment based features are \hat{M}_{20,d} and \hat{M}_{40,d}. The method of determining such moment based features is described in a publication entitled, “Blind modulation classification in the presence of carrier frequency offset”, by V. Chaithanya and V. U. Reddy, in Proc. 8th International Conf. on Signal Processing and Communications, pp. 1-5, July 2010, which is herein incorporated by reference in its entirety.

For example, for the differentially processed sequence S_{dp,i}, various moment based the features may be defined as:

M_{21,s}=E[|Sᵢ|²] (9)

M_{20,s}_{_{dp}}=E[S²_{dp,i}] (10)

M_{40,s}_{_{dp}}=E[S⁴_{dp,1}] (11)

The relationship between the moment based features of d_{dp}(i) and those of S_{dp,i} is given by:

$$\begin{matrix}\vert {M}_{20 , {s}_{dp}} \vert = \frac{\vert {M}_{20 , {s}_{dp}} \vert}{{( {M}_{21 , d} - {σ}^{2} )}^{2}} & ( 12 ) \\ \vert {M}_{40 , {s}_{dp}} \vert = \frac{\vert {M}_{40 , {s}_{dp}} \vert}{{( {M}_{21 , d} - {σ}^{2} )}^{4}} & ( 13 )\end{matrix}$$

For a finite sequence of length N, M_{21,d} may be determined using following equation:

$${\hat{M}}_{21 , d} = \frac{1}{N} {\sum }_{i = 0}^{N - 1} {\vert d ( i ) \vert}^{2} \qquad ( 14 )$$

Where \hat{M}_{21,d} is the finite data estimate of M_{21,d}. Similarly, the finite data estimates of the equations 11 and 12 may also be obtained.

At step 222, a check is made to see if the value of \hat{M}_{20,s}_{_{dp}} (e.g., |\hat{M}_{20,s}_{_{dp}}|) is greater than 0.5. If |\hat{M}_{20,s}_{_{dp}}| is greater than 0.5, at step 224, the decision module 122 determines the modulation format as PSK-2. If |\hat{M}_{20,s}_{_{dp}}| is not greater than 0.5, another check is performed at step 226.

At step 226, another check is made to see if the value of \hat{M}_{40,s}_{_{dp}} (e.g., |\hat{M}_{40,s}_{_{dp}}|) is greater than 0.5. If |\hat{M}_{40,s}_{_{dp}}| is greater than 0.5, at step 228, the decision module 122 determines the modulation format as PSK-4. If |\hat{M}_{40,s}_{_{dp}}| is not greater than 0.5, at step 230, the decision module 122 determines the modulation format as PSK-8.

Embodiments of the present invention may be provided as a computer program product, which may include a non-transitory computer-readable medium tangibly embodying thereon instructions, which may be used to program a computer (or other electronic devices) to perform a process. The computer-readable medium may include, but is not limited to, fixed (hard) drives, magnetic tape, floppy diskettes, optical disks, compact disc read-only memories (CD-ROMs), and magneto-optical disks, semiconductor memories, such as ROMs, random access memories (RAMs), programmable read-only memories (PROMs), erasable PROMs (EPROMs), electrically erasable PROMs (EEPROMs), flash memory, magnetic or optical cards, or other type of media/machine-readable medium suitable for storing electronic instructions (e.g., computer programming code, such as software or firmware). Moreover, embodiments of the present invention may also be downloaded as one or more computer program products, wherein the program may be transferred from a remote computer to a requesting computer by way of data signals embodied in a carrier wave or other propagation medium via a communication link (e.g., a modem or network connection).

In various embodiments, the article(s) of manufacture (e.g., the computer program products) containing the computer programming code may be used by executing the code directly from the computer-readable medium or by copying the code from the computer-readable medium into another computer-readable medium (e.g., a hard disk, RAM, etc.) or by transmitting the code on a network for remote execution. Various methods described herein may be practiced by combining one or more computer-readable media containing the code according to the present invention with appropriate standard computer hardware to execute the code contained therein. An apparatus for practicing various embodiments of the present invention may involve one or more computers (or one or more processors within a single computer, or one or more processor cores) and storage systems containing or having network access to computer program(s) coded in accordance with various methods described herein, and the method steps of the invention could be accomplished by modules, routines, subroutines, or subparts of a computer program product.

While for purposes of simplicity of explanation, the illustrated methodologies are shown and described as a series of blocks/steps, it is to be appreciated that the methodologies are not limited by the order of the blocks, as some blocks can occur in different orders and/or concurrently with other blocks from that shown and described. Moreover, less than all the illustrated blocks may be required to implement an example methodology. Blocks may be combined or separated into multiple components. Furthermore, additional and/or alternative methodologies can employ additional, not illustrated blocks.

Various embodiments of the wireless receiver capable of determining the modulation format of received signal have been disclosed. It should be apparent, however, to those skilled in the art that many more modifications besides those already described are possible without departing from the inventive concepts herein. The embodiments, therefore, are not to be restricted except in the spirit of the disclosure. Moreover, in interpreting the disclosure, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced.

Various embodiments described above have numerous advantages. As described above, the wireless receiver as described in various embodiments is an intelligent wireless receiver which is capable of determining the modulation format of the received signal in presence of one or more of the multipath channels, frequency offsets, phase offsets, timing offsets and noise. Thus, signal having unknown modulation formats (e.g., enemy communications) can be decoded and listened. Further, proposed wireless receiver can classify PSK modulation schemes without a priori knowledge of the pulse shape used in the transmitter, frequency offsets, type and length of the channel through which the signal has been propagated through.

In the foregoing description, certain terms have been used for brevity, clearness, and understanding. No unnecessary limitations are to be implied there from beyond the requirement of the prior art because such terms are used for descriptive purposes and are intended to be broadly construed. Therefore, the invention is not limited to the specific details, the representative embodiments, and illustrative examples shown and described. Thus, this application is intended to embrace alterations, modifications, and variations that fall within the scope of the appended claims.

What is claimed is:

1. A method for determining a modulation format of a transmitted signal from a received signal over a multipath channel, wherein the received signal has a frequency offset with respect to the transmitted signal, the method comprising:
in a wireless receiver:
down-sampling the received signal to obtain a second down-sampled signal at a second predefined rate;
equalizing the second down-sampled signal in order to mitigate effect of the multipath channel;
applying differential processing on the equalized second down-sampled signal to convert the frequency offset into a constant phase offset;
determining values of one or more moment based features for the equalized second down-sampled signal; and
determining the modulation format of the received signal based on the values of one or more moment based features.

2. The method of claim 1 further comprising down-sampling the received signal to obtain a first down-sampled signal at a first predefined rate.

3. The method of claim 2 further comprising determining a second order cyclic autocorrelation function based on the first down-sampled signal.

4. The method of claim 3, wherein the modulation format is determined as an Offset Quadrature Phase Shift Keying depending on a presence of a second order cyclic frequency determined based on the second order cyclic autocorrelation function.

5. The method of claim 1 further comprising determining one or more equalizer coefficients based on the second down-sampled signal by applying a Blind CMA technique, wherein the equalizing is performed based on the one or more estimated equalizer coefficients.

6. The method of claim 1, wherein the modulation format is determined as any of Phase Shift Keying (PSK)-2, PSK-4, or PSK-8 depending on a comparison between the values of the one or more moment based features and a threshold value.

7. A wireless receiver for determining a modulation format of a transmitted signal from a received signal over a multipath channel, wherein the received signal has a frequency offset with respect to the transmitted signal, the wireless receiver comprising:
a signal processor; and
a memory comprising:
an equalizer module for equalizing a second down-sampled signal in order to mitigate an effect of the multipath channel, wherein the second down-sampled signal is obtained from the received signal,
a differential processing module for converting frequency the offset into a constant phase offset in the equalized second down-sampled signal, and
a decision module for determining the modulation format of the received signal based on values of one or more moment based features, wherein the signal processor is operable to execute the sampling module, the equalizer module, the differential processing module, and the decision module.

8. The wireless receiver of claim 7, further comprising a signal detection module for detecting the received signal.

9. The wireless receiver of claim 7, further comprising a sampler for down-sampling the received signal to obtain a first down-sampled signal at a first predefined rate.

10. The wireless receiver of claim 9, wherein the sampler is further configured for down-sampling the received signal to obtain the second down-sampled signal at a second predefined rate.

11. The wireless receiver of claim 9, wherein the memory further comprises an auto correlation determination module for determining a second order cyclic autocorrelation function based on the first down-sampled signal.

12. The wireless receiver of claim 11, wherein the decision module determines the modulation format as an Offset Quadrature Phase Shift Keying depending on a presence of a second order cyclic frequency determined based on the second order cyclic autocorrelation function.

13. The wireless receiver of claim 7, wherein the equalizer module is further configured for determining one or more equalizer coefficients based on the second down-sampled signal by applying a Blind CMA technique, wherein the equalizing is performed based on the one or more estimated equalizer coefficients.

14. The wireless receiver of claim 7, wherein the decision module determines the modulation format as any of PSK-2, PSK-4, or PSK-8 depending on a comparison between the values of the one or more moment based features and a threshold value.

15. The wireless receiver of claim 7 further comprising a demodulator for demodulating the received signal based on the determination of the modulation format.

16. A computer program product for use with a computer, the computer program product comprising a computer readable medium embodied therein a computer program code for determining a modulation format of a transmitted signal from a received signal over a multipath channel, wherein the received signal has a frequency offset with respect to the transmitted signal, the computer program code comprises program instructions for:
down-sampling the received signal;
equalizing the down-sampled signal in order to mitigate an effect of the multipath channel;
applying differential processing on the equalized signal to convert the frequency offset into a constant phase offset;
determining values of one or more moment based features for the equalized signal; and
determining the modulation format of the received signal based on the values of one or more moment based features.
